(19) United States
(12) Patent Application Publication
(10) Pub. No.: US 2005/0162873 A1
(43) Pub. Date: Jul. 28, 2005

(54) Flip-flop based self-oscillating power supply

(76) Inventor: Hendrik Jan Boswinkel, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/505,996

(22) PCT Filed: Feb. 12, 2003
(86) PCT No.: PCT/IB03/00565

(30) Foreign Application Priority Data
Mar. 1, 2002 (EP) 02075817.3

(51) Int. Cl. H02M 3/335

(52) U.S. Cl. 363/20

(57) ABSTRACT

The present invention relates to a switched mode power supply for supplying current from an input voltage source to an electrical loa (OUPUT). The invention is based on the idea that the switching transistor (T1) of the power supply, i.e. the transistor (T1) controlling the conduction of current through the primary winding of the transformer (L2), is driven by a digital device (U1B, U1C). By using a digital device (U1B, U1C), very short ON-times can be realized, which results in the fact that a transformer (L2) with a small primary inductance can be employed, leading to a smaller transformer (L2).

The present invention relates to a switched mode power supply for supplying current from an input voltage source to an electrical load, comprising a self-oscillating flyback converter having a transformer whose primary winding, in series arrangement with a first transistor, is connected in parallel with the input voltage source, which first transistor controls the conduction of current through said primary winding, wherein a feedback path from the secondary winding of the transformer is connected to a control circuit arranged to control said first transistor.

In the prior art, a number of different switched mode power supplies is known. One of said switched mode power supplies is a self oscillating power supply, utilizing a transformer with three windings. The third, auxiliary, winding does not participate in the energy conversion from the primary winding to the secondary winding, but acts as a feed forward for driving the switching transistor in the oscillating power supply. The switching transistor used is in general a MOSFET. When the MOSFET starts conducting, the voltage across the primary winding will increase and the voltage across the auxiliary winding will increase, giving the gate extra drive, thereby making the MOSFET even more conducting. By utilizing the auxiliary winding in this manner, the MOSFET is switched on rapidly, resulting in a minimum of losses. However, when producing for example battery chargers, the most expensive component is the transformer. A transformer with three windings is more expensive than one with two windings. Of course, a transformer with three windings is bulkier as well. As can be seen from the above, utilizing a transformer with two windings is preferred, if possible.

A switched mode power supply utilizing a transformer with two windings is known from U.S. Pat. No. 5,625,540. If a transformer with two windings is used, driving of the switching transistor must be performed by means other than the auxiliary winding, which in the case of a transformer with two windings no longer exists. Existing solutions utilizing a transformer with two windings present all-analog solutions as driving means for the switching transistor.

A problem with analog components is that they are slow due to parasitic capacitances and saturation of transistors, which means that it is difficult to realize short ON-times. Longer ON-times also result in the fact that a transformer with larger primary inductance must be chosen, leading to larger transformers.

An object of the present invention is therefore to rapidly turn the switching transistor on and off.

This object is achieved by a switched mode power supply for supplying current from an input voltage source to an electrical load, comprising a self-oscillating flyback converter having a transformer whose primary winding, in series arrangement with a first transistor, is connected in parallel with the input voltage source, which first transistor controls the conduction of current through-said primary winding, wherein a feedback path from the secondary winding of the transformer is connected to a control circuit arranged to control said first transistor, causing the switching frequency to decrease when the output voltage reaches a predetermined level according to claim 1.

According to an aspect of the invention, a switched mode power supply is provided where a digital device is used to control the switching transistor, the operation of the digital device being controlled by feedback paths in the power supply.

The invention according to this aspect thus provides a switched mode power supply where the switching transistor of the power supply, i.e. the transistor controlling the conduction of current through the primary winding of the transformer, is driven by a digital device. By using a digital device, the feed forward can be made very strong, and thus very short ON-times can be realized. An advantage of this is that a transformer with a smaller primary inductance can be employed.

A digital device controls the conduction of current through a first transistor connected in series with the primary winding. Said first transistor controls the conduction of current through the primary winding and thus operates the output of the power supply. The digital device is operated by three feedback paths, the first feedback path being connected to a first input of the digital device, and the second feedback path as well as the secondary winding feedback path being connected to a second input of the digital device.

According to an embodiment of the invention, said first feedback path consists of a second transistor connected to the first input of the digital device. When the first transistor starts to conduct, the second transistor will start to conduct as well, when the potential of the control electrode reaches a sufficient level. The second transistor causes the input of the device to be switched between a logic low and a logic high level. The second feedback path consists of a third transistor connected in parallel with a first capacitor. The capacitor is connected to the second input of the digital device and the third transistor controls the charge and discharge of the capacitor, thereby causing the second input of the digital device to be switched between a logic high and a logic low level. This second input is also connected to the secondary side of the transformer via a feedback path from the secondary winding. If the output voltage of the switched mode power supply reaches a predetermined level the digital device is operated to lower the switching frequency, thereby decreasing the power supply output voltage.

According to another embodiment of the invention, the digital device can be supplied with power from the main current path of the first transistor. If the supply current of the digital device is drawn from the input of the switched mode power supply via a resistor, considerable power losses will occur in the resistor due to voltage swings in the switched mode power supply input. This is avoided by feeding the digital device from the first transistor.

According to yet another embodiment of the invention, a supply voltage control circuit is provided, turning the digital device power supply on and off. A capacitor is connected to the input of the switched mode power supply. When the voltage across this capacitor reaches a predetermined level, its charge is transferred to another capacitor, and the digital device is switched on. When the voltage decreases below a certain level, a transistor discharges this charged capacitor, turning the digital device off. A high pass filter affected by the voltage across the capacitor turns the transistor off when the voltage rises initially at startup, enabling the capacitor to reach a sufficient voltage level for the digital device to turn on.

Further features of, and advantages obtainable with, the present invention will become apparent when studying the appended claims and the following description.

The present invention will be described in greater detail with reference to the accompanying drawings, in which:

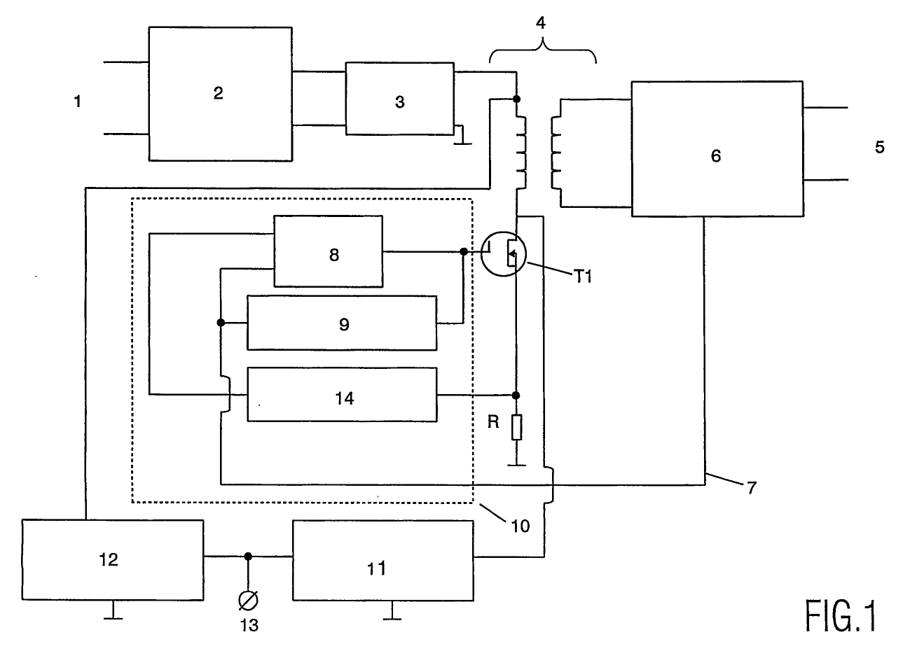

FIG. 1 shows a schematic block diagram of the present invention;

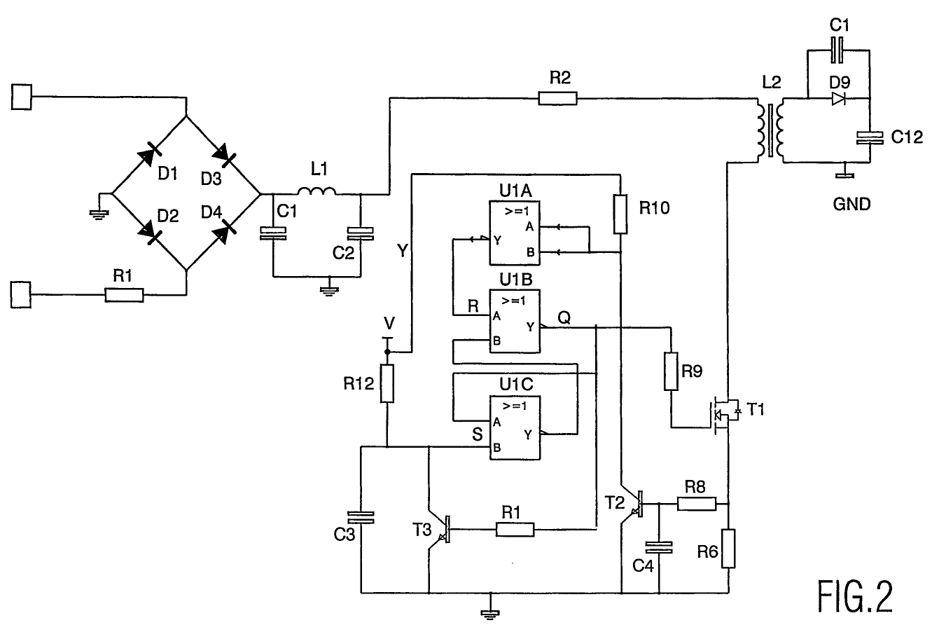

FIG. 2 shows a schematic circuit diagram of the control circuit controlling the switching transistor according to an embodiment of the present invention;

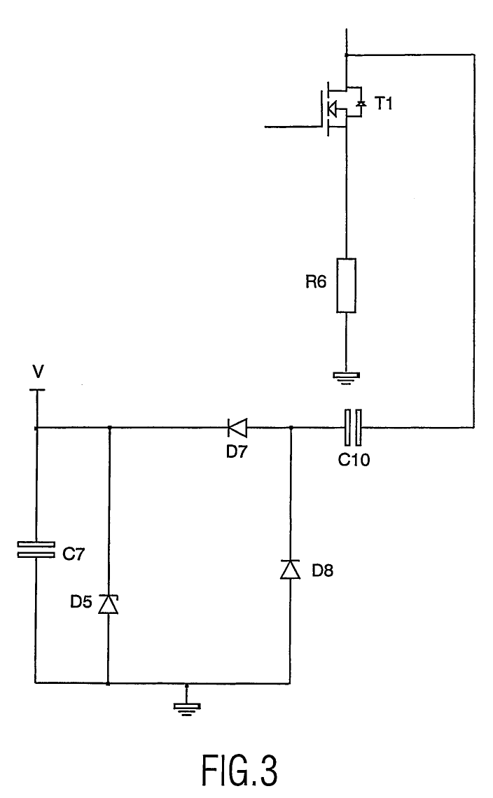

FIG. 3 shows a schematic circuit diagram of the power supply circuit for the digital device according to an embodiment of the present invention;

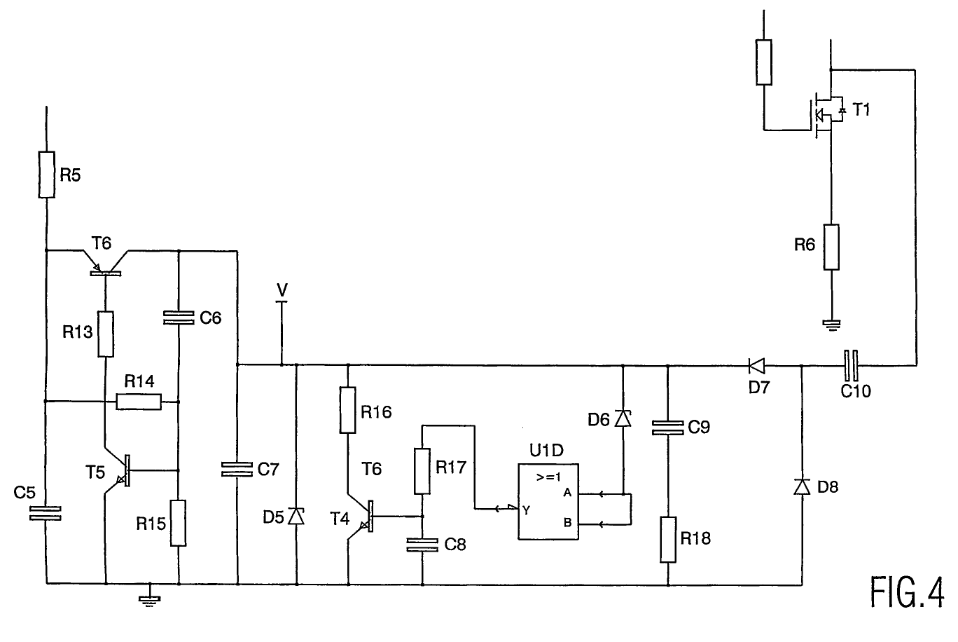

FIG. 4 shows a schematic circuit diagram of the supply voltage control circuit used to turn the power supply for the digital device on and off according to an embodiment of the present invention;

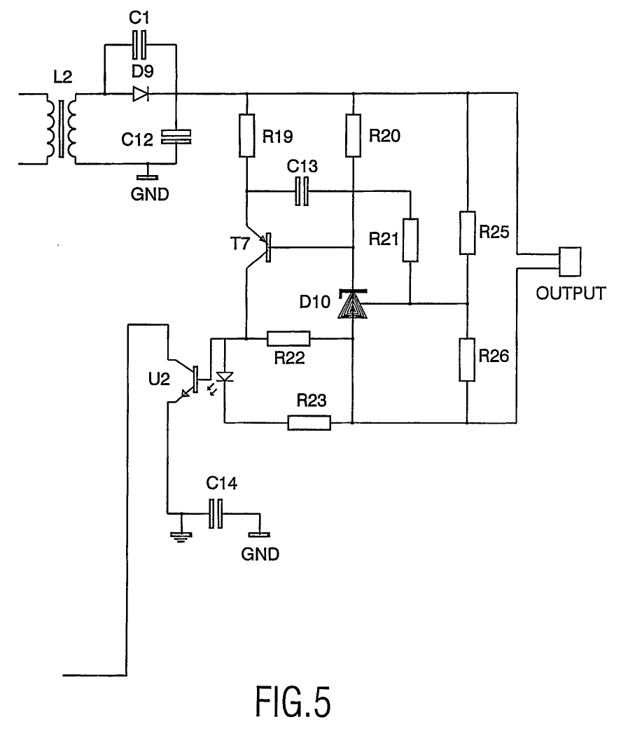

FIG. 5 shows a schematic circuit diagram of the circuit connected to the secondary side of the transformer according to an embodiment of the present invention; and

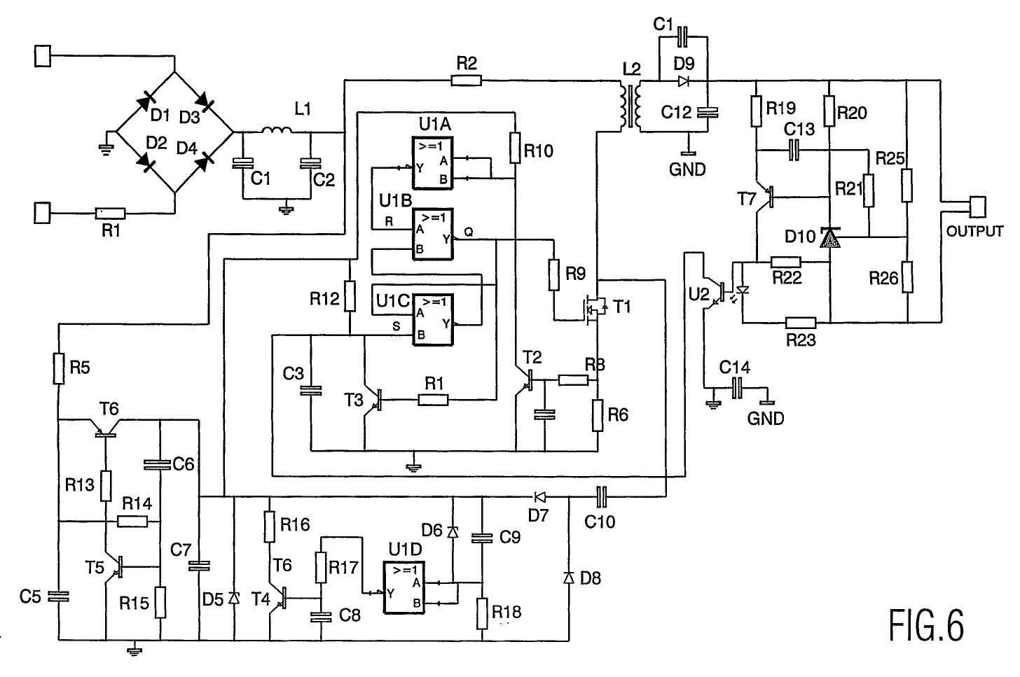

FIG. 6 shows the complete schematic circuit diagram according to an embodiment of the present invention.

A schematic block diagram of a switched mode power supply according to the invention is shown in FIG. 1. It comprises a flyback converter fed from an AC or DC supply 1 via a full-wave bridge rectifier 2 and a filter 3 for filtering and smoothing the input voltage 1. Connected in parallel with the input voltage 1 is the series arrangement of a primary winding of a transformer 4 and a transistor T1. When transistor T1 is in its conducting mode, a current will flow through the primary winding and this current will induce a voltage in the secondary winding. During the conducting interval, the primary current will increase linearly until transistor T1 is switched off. In the flyback interval which then begins, the polarity of the secondary winding is reversed and the energy stored in the transformer 4 is transferred to the power supply output 5. Connected to the secondary winding of the transformer 4 is an optocoupler diode 6, optically isolating the feedback path 7 of the secondary side from the switched mode power supply output 5. The secondary side feedback path 7 is connected to the digital device 8 controlling the switching transistor T1. When a predetermined voltage is reached at the power supply output 5, a current starts to flow through the optocoupler diode 6 and, as a result, also through an optocoupler transistor (not shown). Because of the current through the optocoupler transistor, a capacitor comprised in the second feedback path 9, which path is connected to the secondary winding feedback path 7, is charged much more slowly, which results in a decrease in switching frequency and thus in a reduction of the output voltage 5. In this way, the output voltage 5 of the switched mode power supply will be regulated by controlling the switching frequency of said supply. The switch control circuit 10 is arranged to switch the transistor T1 on and off with a frequency that depends on the power which is drawn from the output 5 of the switched mode power supply. The supply voltage 13 of the digital device 8 is taken from the power supply circuit 11. The supply voltage control circuit 12 is arranged to turn the supply voltage 13 on and off at startup of the switched mode power supply. A first feedback path 14 is also connected to the digital device 8, which first feedback path 14 helps control the conduction of current through the primary winding. This path, and the second feedback path 9, will hereinafter be described in detail.

FIG. 2 shows a schematic circuit diagram of the control circuit controlling the switching transistor T1, thereby controlling the conduction of current through the primary winding of transformer L2. Here, the digital device is shown in the form of an RS-latch consisting of the NOR-gates U1B and U1C. ANOR-gate U1A in inverter configuration is connected to the reset input of the latch. Assuming that the output of the RS-latch is reset, the reset input R of the latch will be pulled low, since it is connected to a logic high level via the inverter U1A and the pull-up resistor R10. The capacitor C3 is charged via the resistor R12 by voltage V until it reaches a predetermined voltage level. When this voltage level is reached, causing the set input S of the latch to reach a logic high level, a logic high level on the latch output Q will be obtained. The latch output Q is connected to the gate of transistor T1 via a resistor R9, and a high logic level on the latch output Q will cause the transistor T1 to start conducting. The latch output is also connected to the base of the transistor T3 via the resistor R11, and a high logic level on the latch output Q will also cause transistor T3 to start conducting at the same time transistor T1 starts to conduct. The conduction of T3 will cause the capacitor C3 to discharge. This will bring the set input S to a low level and since the reset input R is still low, the latch will go into memory mode, maintaining its output Q at a high level. The source of transistor T1 is connected to the base of transistor T2 via a resistor R8. Since transistor T1 is in the conducting mode, the voltage at the node where resistor R8 is connected to the source of transistor T1 is rising due to the linear rising current through the primary winding of transformer L2, the maximum value of the current being set by resistor R6. When this voltage exceeds the base-emitter voltage of transistor T2, transistor T2 will start to conduct. This results in the fact that the input of the inverter U1A is pulled to ground, i.e. logic low level. As a result, the reset input R is increased to a high level and the output Q of the latch is reset, thereby switching off transistor T1 and transistor T3. This operation is subsequently repeated at a predetermined frequency.

FIG. 3 shows a schematic circuit diagram of the power supply circuit for the digital devices. Because of the large possible voltage range of the rectified input voltage, it is not possible to supply the digital devices with power by connecting said power supply circuit via a resistor to this input voltage. This would result in great power losses in said resistor. This problem can be solved by supplying the digital devices with power from the drain of the transistor T1 as shown in FIG. 3. The capacitor C10 and diode D8 forms a clamp circuit used to draw power from the drain signal of transistor T1. This voltage will charge capacitor C7, from which the supply voltage V for the digital devices is taken. When T1 is switched off and the drain voltage rises, C10 and C7 are charged via D7. When T1 is switched on and the drain voltage falls, C10 is discharged via D8. The discharge of C10 enables further charging of C7 when T1 is switched off again. The zener diode D5 is used as a voltage regulator. Because capacitance is added to the drain of transistor T1, this capacitance is discharged when transistor T1 is switched on. This causes a high peak current through transistor T1. Referring to FIG. 2, this high peak current will cause a peak voltage across resistor R6 connected to the source of transistor T1. This peak voltage will turn transistor T2 on, thereby turning transistor T1 off, resulting in the fact that the circuit starts to oscillate. In order to prevent this, a low pass filter comprising R8 and C4 is provided at the base of transistor T3.

FIG. 4 shows a schematic circuit diagram of the supply voltage control circuit used to turn the power supply for the digital devices on and off Capacitor C5 is charged via resistor R5 by the rectified input voltage of the switched mode power supply. Transistor T5 is voltage-divider biased by resistors R14 and R15, and transistor T5 starts to conduct when the voltage divider tap connected to the base exceeds the base-emitter voltage. The base of pnp transistor T6 will be pulled to ground via T5 and, consequently, T6 will start to conduct. C6 will act as a feed forward and T6 will be fully switched on. This will cause the voltage across capacitor C5 to be transferred to capacitor C7 and the digital devices will be switched on when the voltage V across C7 reaches a sufficient level.

When the voltage V across capacitor C7 decreases to a level below the sum of the zener voltage of zener diode D6 and the voltage input for logic low of inverter U1D, the input of inverter U1D will be low and the output will, consequently, be high. This will cause transistor T4 to start conducting. The voltage across capacitor C7 will discharge to ground via transistor T4, thus turning off the digital device supply voltage V.

It is noted that when the circuit starts up, the input voltage of inverter U1D is low, causing transistor T6 to conduct immediately after the supply voltage V to inverter U1D is present. To prevent this, two filters are provided: one low pass filter consisting of R17 and C8 connected to the base of transistor T6 and one high pass filter consisting of R18 and C9 connected to the input of inverter U1D. The low pass filter removes spikes from the output of inverter U1D and the high pass filter places transistor T4 in a non-conductive mode when the voltage across capacitor C7 is rising at startup, which non-conducting mode prevents capacitor C7 from discharging.

FIG. 5 shows a schematic circuit diagram of the circuit connected to the secondary side of the transformer. This circuit acts as a voltage control as well as a current control and is typical of a battery charger. When an empty battery (V_{BATT}=0V) is connected to the output of the charger, the output is shortcut. For that reason the output current of the charger has to be limited until the nominal battery voltage is reached. When the nominal battery voltage is reached, the voltage control takes over, preventing the battery from overcharging.

When the switching transistor T1 is in its non-conducting mode, the energy stored in the transformer is transferred to the power supply output. R22, R23 and the optocoupler diode together act as a current control: when due to the output current the voltage across R23 exceeds the threshold voltage of the optocoupler diode, current starts to flow through the optocoupler diode. This current is transferred to capacitor C3 on the primary side and the switching frequency is decreased, causing a decrease of the output current of the switched mode power supply. When the output voltage reaches its nominal value, the voltage control takes over. Resistors R25 and R26 form a voltage divider. When the voltage on the gate (connected to the voltage divider tap) of voltage regulator D10 exceeds a predetermined voltage level, the current flow into the cathode of regulator D10 connected to resistor R20 increases and causes a large voltage drop across R20, resulting in a larger current through the optocoupler diode. This current is transferred to capacitor C3 on the primary side and the switching frequency is decreased, causing a decrease of the output voltage of the switched mode power supply.

FIG. 6 shows a complete schematic circuit diagram according to the present invention. The description of the complete circuit diagram is given by studying each of the previous drawings.

Even though the invention has been described with reference to specific exemplifying embodiments thereof, many different alterations, modifications and the like will be apparent to those skilled in the art. The embodiments described are therefore not intended to limit the scope of the invention, as defined by the appended claims.

In summary, the present invention relates to a switched mode power supply for supplying current from an input voltage source to an electrical load. The invention is based on the idea that the switching transistor of the power supply, i.e. the transistor controlling the conduction of current through the primary winding of the transformer, is driven by a digital device. By using a digital device, very short ON-times can be realized, which results in the fact that a transformer with a small primary inductance can be employed, leading to a smaller transformer.

1. A switched mode power supply for supplying current from an input voltage source to an electrical load, comprising a self-oscillating flyback converter having a transformer (L2) whose primary winding, in series arrangement with a first transistor (T1), is connected in parallel with the input voltage source, which first transistor (T1) controls the conduction of current through said primary winding, wherein a feedback path from the secondary winding of the transformer is connected to a control circuit arranged to control said first transistor (T1), causing the switching frequency to decrease when the output voltage reaches a predetermined level, characterized in that said control circuit includes a digital device (U1B, U1C) arranged to control the switching of said power supply by means of controlling said first transistor (T1), wherein the operation of said digital device (U1B, U1C) is controlled by said conduction of current through the primary winding via a first feedback path and by said digital device (U1B, U1C) itself via a second feedback path, said second feedback path also being connected to the feedback path from the secondary winding.

2. The switched mode power supply as claimed in claim 1, wherein said first feedback path consists of a second transistor (T2) connected to the first input of said digital device (U1B, U1C), which second transistor (T2) causes said first input to be switched between a logic high and a logic low level, and wherein said second feedback consists of a third transistor (T3) connected in parallel with a first capacitor (C3), which capacitor (C3) is connected to the second input of said digital device (U1B, U1C), wherein said third transistor (T3) controls the charging and discharging of said first capacitor (C3), thereby causing said second input to be switched between a logic high and a logic low level.

3. The switched mode power supply as claimed in claim 2, wherein the control electrode of the second transistor (T2) is connected to the first main electrode of said first transistor (T1), and wherein the second main electrode of said second transistor (T2) is connected to said first input, via a first inverter (U1A), of the digital device (U1B, U1C) and the first main electrode of the second transistor (T2) is connected to ground, wherein said first input of the digital device (U1B, U1C) will be set to a logic low level via the first inverter (U1A) and a pull-up resistor (R10) when said second transistor (T2) is in the non-conducting mode and to a logic high level when said second transistor (T2) is in the conducting mode.

4. The switched mode power supply as claimed in claim 2, wherein the output of said digital device (U1B, U1C) is connected to the control electrode of said third transistor (T3), which main current path of said third transistor (T3) is connected in parallel with said first capacitor (C3), wherein the capacitor (C3) is connected to the second input of the digital device (U1B, U1C) and which capacitor (C3) is charged by a voltage via a first resistor (R12), and wherein the capacitor (C3) will charge to a logic high level at said second input of the digital device (U1B, U1C) when said third transistor (T3) is in the non-conducting mode, and wherein the capacitor (C3) will discharge through said third transistor (T3) to a logic low level at said second input of said digital device (U1B, U1C) when said third transistor (T3) is in the conducting mode.

5. The switched mode power supply as claimed in claim 2, wherein said digital device (U1B, U1C) is supplied with power from the main current path of said first transistor (T1), and wherein the voltage that charges said first capacitor (C3) is taken from the main current path of said first transistor (T1).

6. The switched mode power supply as claimed in claim 1, wherein a supply voltage control circuit is provided, which supply voltage control circuit turns the digital device power supply on and off, said digital device power supply being turned on when a second capacitor (C5) is charged via a second resistor (R5) by the input voltage of the switched mode power supply, said charge being transferred to a third capacitor (C7) when the voltage reaches a predetermined level, the third capacitor (C7) providing the supply voltage to said digital device (U1B, U1C), and said digital device power supply being turned off when the voltage across the third capacitor (C7) decreases to a predetermined level, causing a fourth transistor (T4) to discharge said third capacitor (C7).

7. The switched mode power supply as claimed in claim 6, wherein a high pass filter is arranged to place said fourth transistor (T4) in a non-conductive mode when the voltage across said third capacitor (C7) is rising at the startup of said switched mode power supply, which non-conductive mode causes said voltage across said third capacitor (C7) to continue to rise, wherein the digital device power supply is turned on.

8. The switched mode power supply as claimed in claim 6, wherein a series connection of said second resistor (R5) and said second capacitor (C5) is connected in parallel with the switched mode power supply input, which switched mode power supply input charges said second capacitor (C5), said capacitor (C5) being connected in parallel with the main current path of a fifth transistor (T5), said fifth transistor (T5) being voltage-divider biased and having its second main electrode connected to the control electrode of a sixth transistor (T6), said fifth transistor (T5) starting to conduct when the voltage divider tap exceeds a predetermined voltage level, causing said sixth transistor (T6) to start conducting as well, the second main electrode of said sixth transistor (T6) being connected with the second capacitor (C5), wherein said conduction of the sixth transistor (T6) causes the second capacitor (C5) to discharge via said sixth transistor (T6), thereby transferring the charge to said third capacitor (C7), said third capacitor (C7) being connected to the first main electrode of the sixth transistor (T6), the charging of the third capacitor (C7) causing the digital device power supply to be turned on.

9. The switched mode power supply as claimed in claim 6, wherein the cathode of a zener diode (D6) is connected to said third capacitor (C7) and the anode of the zener diode (D6) is connected to a second inverter (U1D) input, the output of said second inverter (U1D) being connected to the control electrode of said fourth transistor (T4), the main current path of the fourth transistor (T4) being connected in parallel with the third capacitor (C7), which capacitor (C7) will discharge through the fourth transistor (T4) when the transistor (T4) is in its conducting mode, which occurs when the voltage across the third capacitor (C7) drops below the sum of the zener voltage of the zener diode (D6) and the voltage input level for logic low of the second inverter (U1D), thereby causing the digital device power supply to turn off.

10. The switched mode power supply as claimed in claim 6, wherein a diode clamp circuit (D8, C10) is arranged between the main current path of said first transistor (T1) and said digital device power supply, thereby drawing power from the signal on the second main electrode of the first transistor (T1).

11. The switched mode power supply as claimed in claim 1, wherein said digital device (U1B, U1C) consists of a flip flop.

12. The switched mode power supply as claimed in claim 1, wherein said digital device (U1B, U1C) consists of an RS-latch.
